(19) United States
(12) Patent Application Publication
(10) Pub. No.: US 2019/0203503 A1
(43) Pub. Date: Jul. 4, 2019

(54) ELECTRIC DOOR LOCK DEVICE

(71) Applicant: Gianni Industries Inc., Taipei (TW)

(72) Inventor: Chih Chung CHANG, Taipei (TW)

(21) Appl. No.: 15/856,103

(22) Filed: Dec. 28, 2017

(51) Int. Cl. E05B 47/06

(52) U.S. Cl. CPC E05B 47/0603; E05B 47/0696

(57) ABSTRACT

A door lock device includes a tongue pivotally engaged in a housing, a latch slidably received in the housing for latching the tongue to the housing, a sliding member located above the latch for forcing the latch to engage with the tongue, a follower slidably engaged in the sliding member and having a projection for moving the sliding member away from the tongue, a lever arm is pivotally attached to the housing and includes an end portion engaged with the follower for moving the follower up and down relative to the sliding member and the housing, a rotary member is attached to the housing and includes a stud engaged with the lever arm for rotating the lever arm relative to the housing, and a link is slidably engaged in the housing and connected to the rotary member.

### BACKGROUND OF THE INVENTION

### 1. Field of the Invention

The present invention relates to a door lock device, and more particularly to an electric door lock device including a safety structure or mechanism for allowing the electric door lock device to be suitably and safely operated or actuated.

### 2. Description of the Prior Art

Various kinds of typical electromagnetic lock devices, such as electric dropbolts, cathode locks or the like have been developed and provided for conducting or operating or locking and unlocking various door devices, and normally comprise a core or deadbolt actuatable or movable or operatable with a coil or an electromagnetic mechanism to actuate the deadbolt or tongue and to lock or unlock a door or window or the like.

For example, U.S. Pat. No. 4,677,834 to Hicks, U.S. Pat. No. 5,531,086 to Bryant, U.S. Pat. No. 5,566,991 to Young, U.S. Pat. No. 5,934,720 to Karalius, U.S. Pat. No. 6,079,755 to Chang, U.S. Pat. No. 6,302,455 to Huang, U.S. Pat. No. 7,014,226 to Huang, and U.S. Pat. No. 7,237,412 to Huang disclose several of the typical electromagnetic deadbolt lock devices each also comprising a deadbolt or tongue indirectly coupled to an electromagnetic mechanism with a connecting rod for allowing the deadbolt or tongue to be actuated or operated by the electromagnetic mechanism.

However, after the door panel is locked with or by the typical electromagnetic deadbolt lock devices, the deadbolt or tongue may be contacted and forced onto the parts or elements of the electromagnetic deadbolt lock devices with a preload which may have the electromagnetic deadbolt lock devices be jammed such that the electromagnetic deadbolt lock devices may not be easily actuated or operated by the user.

The present invention has arisen to mitigate and/or obviate the afore-described disadvantages of the conventional electromagnetic lock devices.

### SUMMARY OF THE INVENTION

The primary objective of the present invention is to provide an electric door lock device including a safety structure or mechanism for allowing the electric door lock device to be suitably and safely operated or actuated.

In accordance with one aspect of the invention, there is provided a door lock device comprising a housing including a chamber formed in the housing, a tongue pivotally engaged in the chamber of the housing, a latch slidably received in the housing and movable relative to the housing and the tongue for selectively engaging with the tongue and for selectively latching and anchoring the tongue to the housing and for preventing the tongue from being rotated relative to the housing, a sliding member slidably engaged in the chamber of the housing and located above the latch for selectively engaging with the latch and for selectively forcing and moving the latch to engage with the tongue, the sliding member including a passage formed therein, a follower slidably engaged in the passage of the sliding member, and the follower including a projection extended therefrom for selectively engaging with the sliding member and for selectively moving the sliding member to move upwardly away from the tongue, a lever arm including a first end portion pivotally attached to the housing with a pivot pin, and a second end portion engaged with the follower for moving the follower up and down relative to the sliding member and the housing when the lever arm is pivoted relative to the housing, a rotary member rotatably attached to the housing with a pivot shaft, and the rotary member including a stud extended therefrom and separated from the pivot shaft and engaged with the lever arm for rotating the lever arm relative to the housing and for moving the follower up and down relative to the sliding member and the housing, and a link slidably engaged in the housing, and connected to the rotary member for rotating the rotary member relative to the housing and for rotating the lever arm relative to the housing. The tongue may be effectively actuated or operated even when the tongue is preloaded.

The tongue includes a recess formed therein for selectively engaging with the latch. The sliding member includes an ear provided thereon for selectively engaging with the projection of the follower and for moving the follower relative to the housing. The follower includes a slot formed therein for engaging with the second end portion of the lever arm.

The lever arm includes an oblong hole formed therein for engaging with the stud of the rotary member and for allowing the lever arm to be rotated relative to the housing with the rotary member. The housing includes a block attached thereto, the first end portion of the lever arm is pivotally attached to the block of the housing with the pivot pin.

The pivot shaft is engaged with the rotary member and the block for rotatably attaching the rotary member to the block of the housing. The pivot shaft is attached to a shank, and the shank includes a pivot pole extended therefrom and offset from the pivot shaft and engaged with the rotary member and the link for connecting the link to the rotary member.

An actuator may further be provided and engaged in the housing, and the actuator including a mandrel connected to the link for moving the link up and down relative to the housing. A beam may further be provided and pivotally attached to the housing with a pivot pin, and the beam including a pivot rod extended therefrom and engaged with and connected to the link, and a pivot post extended therefrom and offset from the pivot rod and engaged with and connected to the mandrel for allowing the beam to be pivoted relative to the housing by the mandrel and the pivot post.

The housing includes a partition provided thereon, and the partition includes an orifice formed therein for slidably receiving and engaging with the latch. The sliding member includes an aperture formed therein and communicating with the passage of the sliding member for engaging with an anchor and for selectively anchoring the sliding member to the housing.

The housing includes a depression formed therein for selectively receiving and engaging with the anchor and for allowing the sliding member to be selectively anchored to the housing. The follower includes a cam member provided thereon for selectively engaging with the anchor and for selectively forcing and moving the anchor to engage with the housing.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial perspective view of an electric door lock device in accordance with the present invention for a door device, as seen from one direction;

FIG. 2 is a perspective view of the electric door lock device as seen from the other direction;

FIG. 3 is a partial exploded view of the electric door lock device;

FIG. 4 is another partial exploded view of the electric door lock device;

FIG. 5 is a partial plan schematic view illustrating the locking operation of the electric door lock device;

FIG. 6 is another partial plan schematic view similar to FIG. 5, illustrating the unlocking operation of the electric door lock device; and

FIG. 7 is a further partial plan schematic view similar to FIGS. 5 and 6, illustrating the operation of the electric door lock device.

### DETAILED DESCRIPTION OF THE PREFERRED EMBODIMENT

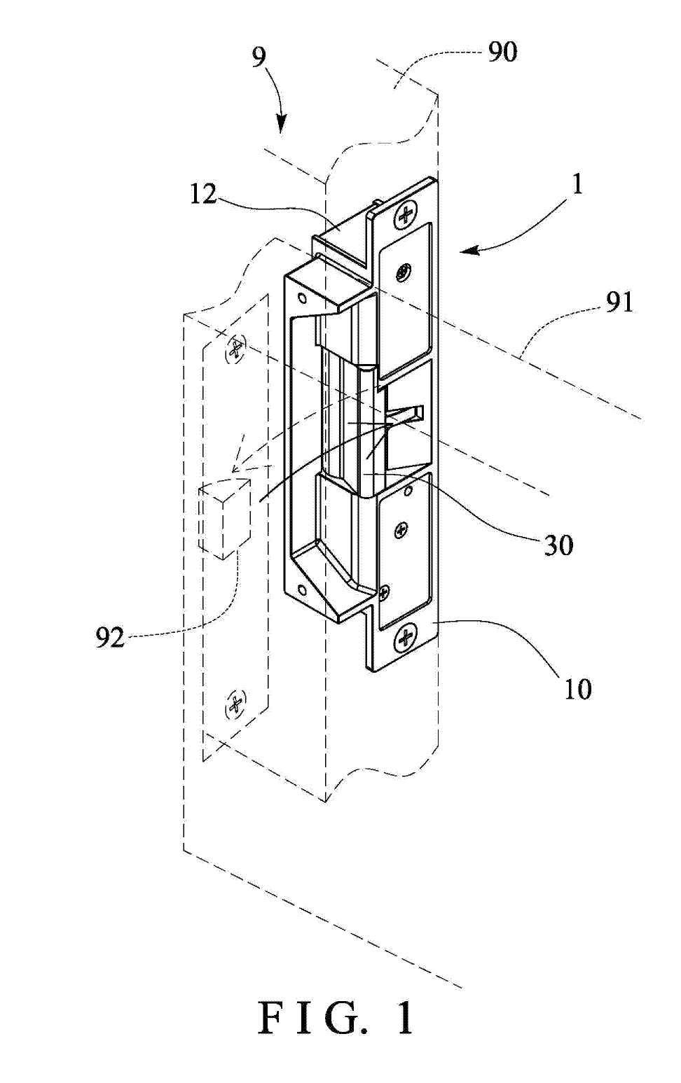

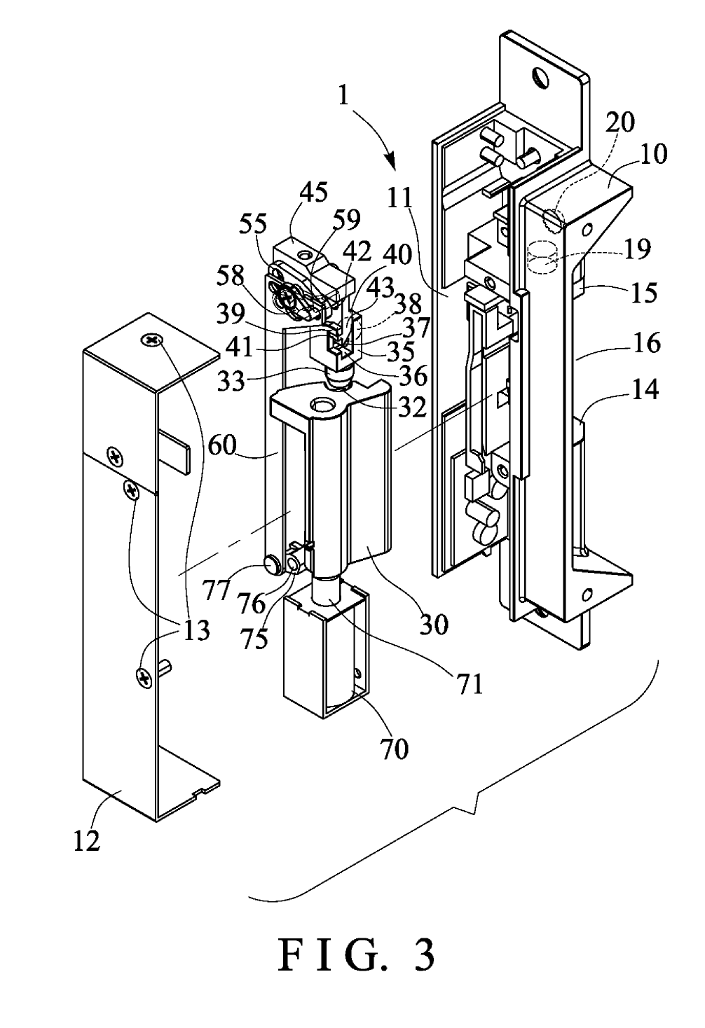

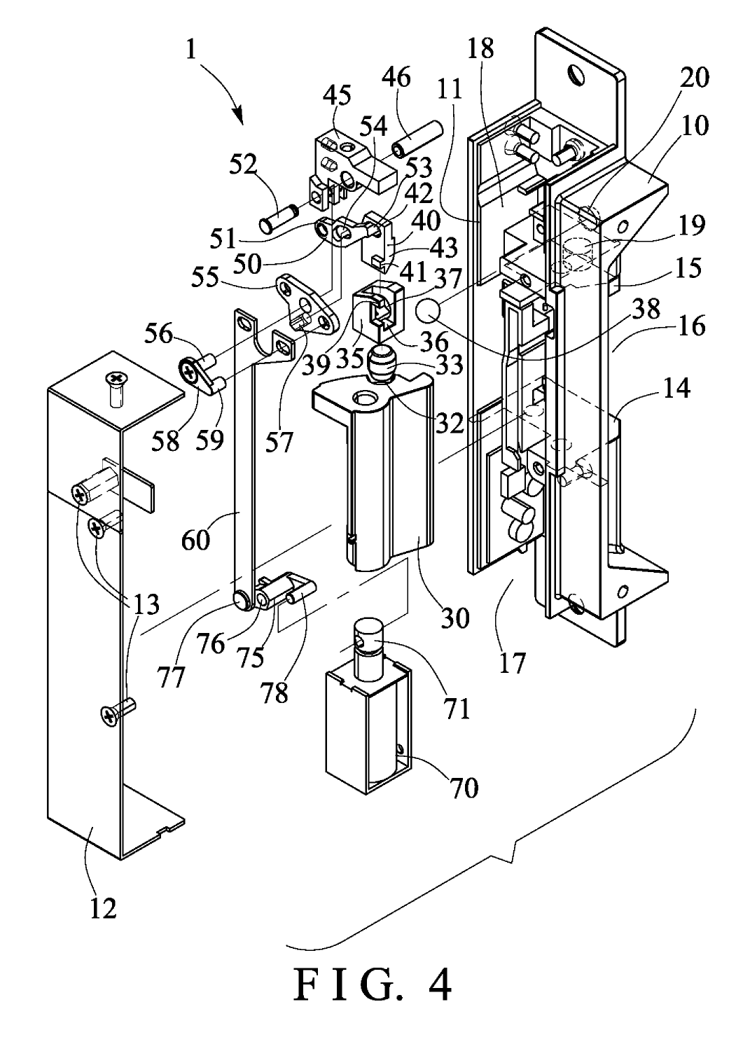

Referring to the drawings, and initially to FIG. 1, an electric door lock device 1 in accordance with the present invention is developed and provided for attaching or mounting or securing to a door member or door panel 90 of a door device 9, for locking and unlocking the door device 9, and the door panel or door member 90 of the door device 9 is worked in cooperate with a door element 91 of the door device 9, such as a door panel, a door frame 91 or the like. The door frame or door element 91 of the door device 9 includes a latch bolt 92 formed or provided or engaged therein. As shown in FIGS. 1-5, the electric door lock device 1 in accordance with the present invention comprises a housing 10 disposed or engaged into the door member 90 (FIG. 1), and including a chamber 11 formed therein (FIGS. 3, 4) for receiving various parts or members or elements or the like therein.

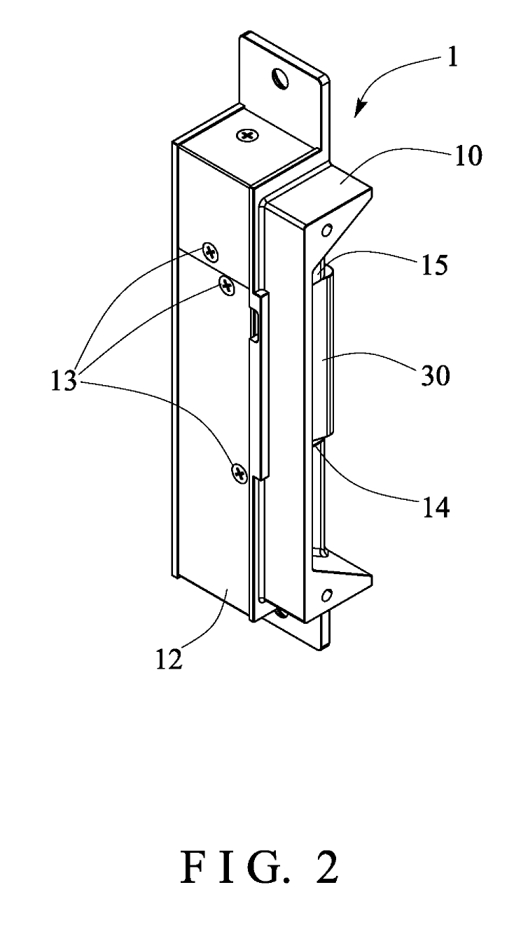

The electric door lock device 1 or the housing 10 includes a cover 12 secured onto the housing 10, such as secured onto the front portion of the housing 10 with such as latches or fasteners 13 for enclosing the chamber 11 of the housing 10 and for anchoring or retaining or positioning the parts or members or elements or the like within the chamber 11 of the housing 10. The housing 10 includes a lower base or platform 14 and an upper plate or partition 15 formed or provided in the chamber 11 of the housing 10 (FIGS. 2-4) and offset or spaced or separated from each other for forming or defining an opening 16 in the housing 10 and between the platform 14 and the partition 15 of the housing 10, and also for forming or defining a lower compartment 17 below the platform 14 and an upper compartment 18 above the partition 15.

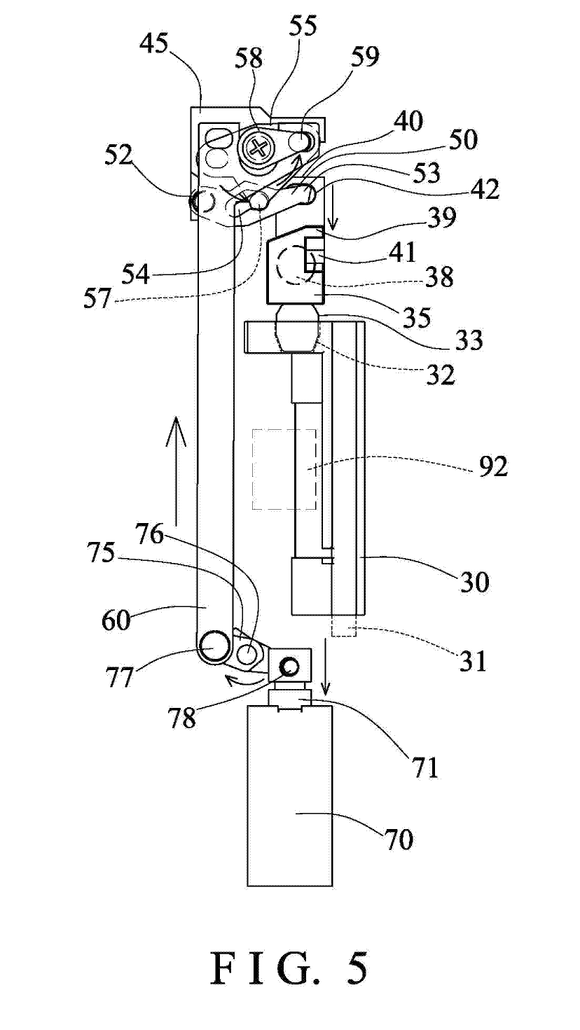

A flap or tongue 30 is pivotally or rotatably received or engaged within the chamber 11 and/or the opening 16 of the housing 10 and pivotally connected or coupled between the platform 14 and the partition 15 with a pivot axle 31 (FIGS. 5-7), and includes a cavity or recess 32 formed in the upper portion of the tongue 30 (FIGS. 3-7) for selectively receiving or engaging with a latch 33 which is slidably received or engaged in an orifice 19 (FIGS. 3, 4) that is formed in the partition 15 of the housing 10; i.e., the latch 33 is slidable and extendible into the opening 16 of the housing 10 and movable relative to the housing 10 for selectively engaging with the recess 32 of the tongue 30 and for selectively latching or anchoring or retaining the tongue 30 to the housing 10 and for preventing the tongue 30 from pivoting or rotating relative to the housing 10.

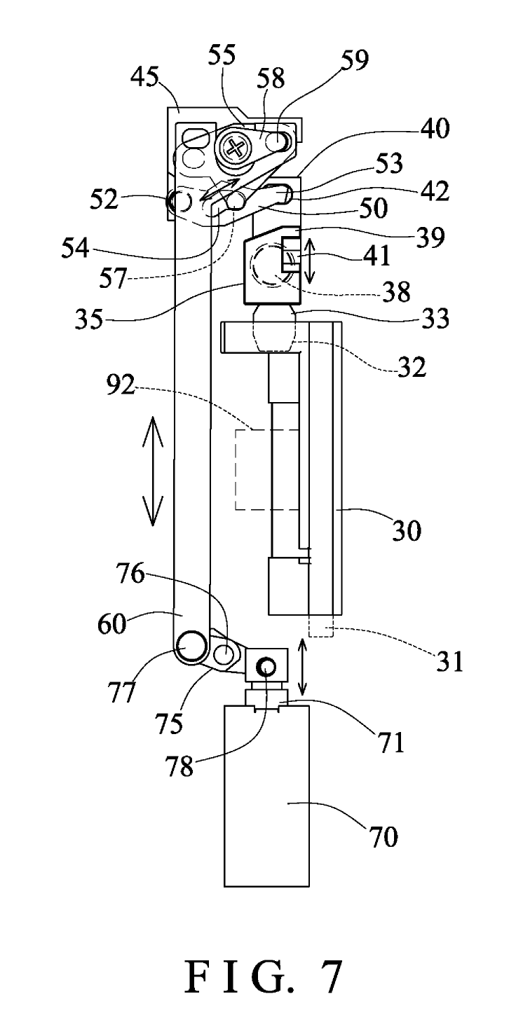

A sliding member 35 is slidably received or engaged in the chamber 11 and/or the upper compartment 18 of the housing 10 and disposed or located above the latch 33 (FIGS. 5-7) for selectively contacting or engaging with the latch 33 and for selectively forcing and moving the latch 33 to engage with the recess 32 of the tongue 30 (FIGS. 5, 7). The sliding member 35 includes a passage 36 formed therein, and includes an aperture 37 formed therein and communicating with the passage 36 of the sliding member 35 for slidably receiving or engaging with a catch or anchor 38 which is selectively receivable or engageable in a cavity or depression 20 (FIGS. 3, 4) that is formed in the housing 10 and aligned with and/or located above the orifice 19 of the partition 15 or of the housing 10.

For example, the anchor 38 is normally received or engaged in the aperture 37 of the sliding member 35, and selectively receivable or engageable into the depression 20 of the housing 10 when the sliding member 35 is moved downwardly to force and move the latch 33 to engage with the recess 32 of the tongue 30. The sliding member 35 further includes a catch or ear 39 formed or provided thereon. Another sliding member or follower 40 is slidably received or engaged in the passage 36 of the sliding member 35 and includes another catch or projection 41 extended therefrom for selectively contacting or engaging with the ear 39 of the sliding member 35 and for selectively moving the sliding member 35 to move upwardly away from the tongue 30 and the partition 15 when the follower 40 is moved upwardly relative to the housing 10.

The follower 40 includes an oblong hole or slot 42 formed therein, and includes a protrusion or cam member 43 formed or provided thereon for selectively contacting or engaging with the anchor 38 and for selectively forcing and moving the anchor 38 to engage with the depression 20 of the housing 10 when the follower 40 is moved downwardly relative to the sliding member 35. When the follower 40 is moved upwardly relative to the sliding member 35, the follower 40 may be offset or spaced or disengaged or separated from the anchor 38 for allowing the anchor 38 to be received or engaged in the aperture 37 of the sliding member 35. The projection 41 of the follower 40 may be contacted or engaged with the ear 39 of the sliding member 35 for moving the sliding member 35 upwardly away from the tongue 30 and the partition 15 when the follower 40 is moved upwardly relative to the housing 10.

A stationary member or block 45 is disposed or engaged in the upper compartment 18 of the housing 10 and attached or mounted or secured to the housing 10 with one or more latches or fasteners or pegs 46. A lever arm 50 includes one or first end portion 51 pivotally or rotatably attached or mounted or secured to the block 45 or the housing 10 with a pivot pin 52, and includes another or second end portion 53 slidably received or engaged in the slot 42 of the follower 40 for allowing the follower 40 to be moved up and down relative to the sliding member 35 and the housing 10 with the lever arm 50 when the lever arm 50 is pivoted or rotated relative to the housing 10. The lever arm 50 includes another slot or oblong hole 54 formed therein, such as formed in the middle or intermediate portion thereof.

Another follower or rotary member 55 is pivotally or rotatably attached or mounted or secured to the block 45 or the housing 10 with one of the pegs 46 or with a pivot shaft 56 which may be secured to the peg 46, and includes a projection or extension or stud 57 extended therefrom and offset or spaced or separated from the pivot shaft 56, and slidably received or engaged in the oblong hole 54 of the lever arm 50 for pivoting or rotating the lever arm 50 relative to the housing 10 and for moving the follower 40 up and down relative to the sliding member 35 and the housing 10 when the rotary member 55 is pivoted or rotated relative to the housing 10. The pivot shaft 56 may be attached or mounted or secured to a link or shank 58 which includes a pivot pole 59 extended therefrom and offset or spaced or separated from the pivot shaft 56, and preferably parallel to the pivot shaft 56.

A further sliding member or lever arm or link 60 is slidably received or engaged in the chamber 11 of the housing 10 and movable up and down relative to the housing 10, the pivot pole 59 is engaged with the upper portion of the link 60 and also engaged with the rotary member 55 for connecting or coupling the upper portion of the link 60 to the rotary member 55, and offset or spaced or separated from the stud 57 for allowing the rotary member 55 to be pivoted or rotated relative to the housing 10 with the link 60 when the link 60 moved up and down relative to the housing 10. A solenoid or actuator 70 is disposed or engaged in the lower compartment 17 of the housing 10 and includes a core or mandrel 71 connected or coupled to the link 60 for moving the link 60 up and down relative to the housing 10.

For example, another link or shank or beam 75 is pivotally or rotatably attached or mounted or secured to the housing 10 with a pivot pin 76, and includes a pivot rod 77 extended therefrom and engaged with and connected or coupled to the link 60 for moving the link 60 up and down relative to the housing 10, and a pivot post 78 extended therefrom and offset or spaced or separated from the pivot rod 77 and engaged with and connected or coupled to the mandrel 71 for allowing the beam 75 to be pivoted or rotated relative to the housing 10 by the stud 57 with the mandrel 71 and the pivot post 78, and thus for allowing the rotary member 55 and the lever arm 50 and the follower 40 to be actuated or operated by the stud 57 with the beam 75.

In operation, the link 60 may be moved up and down relative to the housing 10 by the stud 57 with the beam 75, in order to pivot or rotate the rotary member 55 relative to the housing 10, and then to pivot or rotate the lever arm 50 relative to the housing 10, so as to move the follower 40 up and down relative to the sliding member 35 and the housing 10, and thus to move or actuate the sliding member 35 to engage with the latch 33 which may then be forced and moved to engage with the recess 32 of the tongue 30 and to selectively latch or anchor or retain the tongue 30 to the housing 10 and for preventing the tongue 30 from pivoting or rotating relative to the housing 10.

As shown in FIG. 5, when the mandrel 71 of the actuator 70 is energized or actuated or operated either upwardly or downwardly, the link 60 may be moved up relative to the housing 10, in order to pivot or rotate the rotary member 55 counterclockwise relative to the housing 10, and then to pivot or rotate the lever arm 50 downwardly or clockwise, relative to the housing 10, so as to move the follower 40 downwardly relative to the sliding member 35 and the housing 10, and thus to move or actuate the sliding member 35 to engage with the latch 33 which may then be forced and moved to engage with the recess 32 of the tongue 30 and to selectively latch or anchor or retain the tongue 30 to the housing 10 and for preventing the tongue 30 from pivoting or rotating relative to the housing 10.

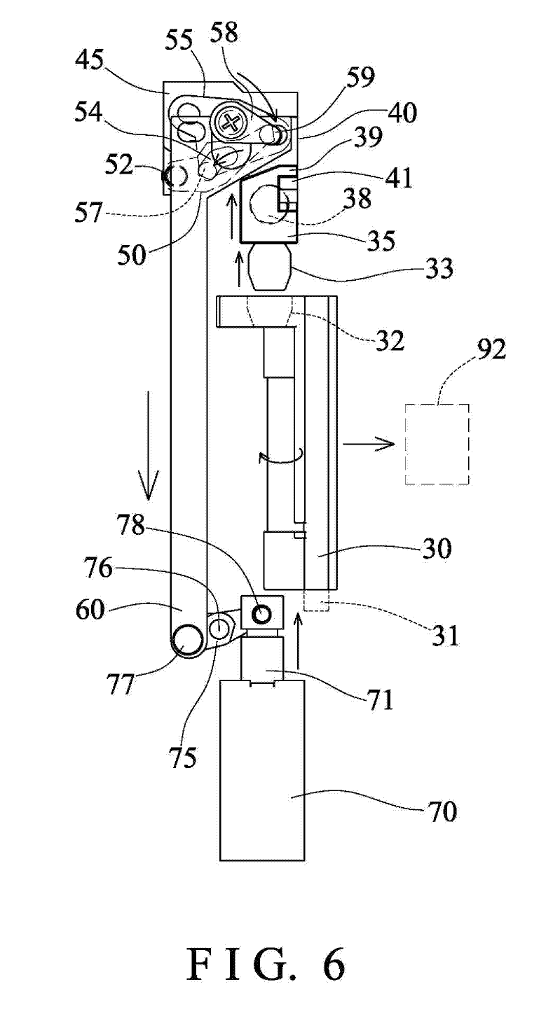

On the contrary, as shown in FIG. 6, when the mandrel 71 of the actuator 70 is actuated or operated upwardly, the link 60 may be moved downwardly relative to the housing 10, in order to pivot or rotate the rotary member 55 clockwise relative to the housing 10, and then to pivot or rotate the lever arm 50 upwardly or counterclockwise, relative to the housing 10, so as to move the follower 40 upwardly relative to the sliding member 35 and the housing 10, and thus to move or actuate the sliding member 35 upwardly and away from the latch 33 which may then be moved and disengaged from the recess 32 of the tongue 30 and to selectively release the tongue 30 and thus for allowing the tongue 30 to be pivoted or rotated relative to the housing 10.

When the latch bolt 92 is contacted or engaged with the tongue 30 and when the latch bolt 92 applies a preload onto or against the tongue 30, the latch 33 may also be easily moved toward or away from the tongue 30 by or with the actuator 70, i.e., the actuation or the operation of the actuator 70 to the latch 33 and the tongue 30 will not be affected or influenced when the tongue 30 is contacted or depressed by the latch bolt 92 with a preload. Instead of the actuator 70, the link 60 and the rotary member 55 and the lever arm 50 and the follower 40 and the sliding member 35 and the latch 33 may be actuated or operated by or with a mechanical device or apparatus (not illustrated) or the like. The tongue 30 may be easily and effectively actuated or operated even when the tongue 30 is preloaded.

Accordingly, the electric door lock device in accordance with the present invention includes a safety structure or mechanism for allowing the electric door lock device to be suitably and safely operated or actuated.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A lock device comprising:
a housing including a chamber formed in said housing;
a tongue pivotally engaged in said chamber of said housing;
a latch slidably received in said housing and movable relative to said housing and said tongue for selectively engaging with said tongue and for selectively latching and anchoring said tongue to said housing and for preventing said tongue from being rotated relative to said housing;
a sliding member slidably engaged in said chamber of said housing and located above said latch for selectively engaging with said latch and for selectively forcing and moving said latch to engage with said tongue, said sliding member including a passage formed therein;
a follower slidably engaged in said passage of said sliding member, and said follower including a projection extended therefrom for selectively engaging with said sliding member and for selectively moving said sliding member to move upwardly away from said tongue;
a lever arm including a first end portion pivotally attached to said housing with a pivot pin, and a second end portion engaged with said follower for moving said follower up and down relative to said sliding member and said housing when said lever arm is pivoted relative to said housing;
a rotary member rotatably attached to said housing with a pivot shaft, and said rotary member including a stud extended therefrom and separated from said pivot shaft and engaged with said lever arm for rotating said lever arm relative to said housing and for moving said follower up and down relative to said sliding member and said housing; and
a link slidably engaged in said housing, and connected to said rotary member for rotating said rotary member relative to said housing and for rotating said lever arm relative to said housing.

2. The lock device as claimed in claim 1, wherein said tongue includes a recess formed therein for selectively engaging with said latch.

3. The lock device as claimed in claim 1, wherein said sliding member includes an ear provided thereon for selectively engaging with said projection of said follower.

4. The lock device as claimed in claim 1, wherein said follower includes a slot formed therein for engaging with said second end portion of said lever arm.

5. The lock device as claimed in claim 1, wherein said lever arm includes an oblong hole formed therein for engaging with said stud of said rotary member.

6. The lock device as claimed in claim 1, wherein said housing includes a block attached thereto, said first end portion of said lever arm is pivotally attached to said block of said housing with said pivot pin.

7. The lock device as claimed in claim 6, wherein said pivot shaft is engaged with said rotary member and said block for rotatably attaching said rotary member to said block of said housing.

8. The lock device as claimed in claim 6, wherein said pivot shaft is attached to a shank, and said shank includes a pivot pole extended therefrom and offset from said pivot shaft and engaged with said rotary member and said link.

9. The lock device as claimed in claim 1 further comprising an actuator engaged in said housing, and said actuator including a mandrel connected to said link for moving said link up and down relative to said housing.

10. The lock device as claimed in claim 9 further comprising a beam pivotally attached to said housing with a pivot pin, and said beam including a pivot rod extended therefrom and engaged with and connected to said link, and a pivot post extended therefrom and offset from said pivot rod and engaged with and connected to said mandrel for allowing said beam to be pivoted relative to said housing by said mandrel and said pivot post.

11. The lock device as claimed in claim 1, wherein said housing includes a partition provided thereon, and said partition includes an orifice formed therein for slidably receiving and engaging with said latch.

12. The lock device as claimed in claim 1, wherein said sliding member includes an aperture formed therein and communicating with said passage of said sliding member for engaging with an anchor.

13. The lock device as claimed in claim 12, wherein said housing includes a depression formed therein for selectively receiving and engaging with said anchor.

14. The lock device as claimed in claim 12, wherein said follower includes a cam member provided thereon for selectively engaging with said anchor.
